(19) United States
(12) Patent Application Publication
(10) Pub. No.: US 2005/0229469 A1
(43) Pub. Date: Oct. 20, 2005

(54) Fish net with releasable attachment

(76) Inventor: Jeff Able, Missoula, MT (US)

Correspondence Address: DAVID R MCKINNEY, 8 EAST BROADWAY, SUITE 500, UTAH, UT, 84111, US

(21) Appl. No.: 11/057,053

(22) Filed: Feb. 11, 2005

Related U.S. Application Data
(63) Continuation of application No. 10/730,871, filed on Dec. 8, 2003, now abandoned.
Application No. 10/730,871 is a continuation-in-part of application No. 10/616,460, filed on Jul. 8, 2003.
Application No. 10/616,460 is a continuation of application No. 10/015,487, filed on Dec. 11, 2001, now Pat. No. 6,615,532.

(51) Int. Cl. A01K 77/00

(52) U.S. Cl. 43/12; 43/11

(57) ABSTRACT

A net for a sport fishing net device having a substantially hoop-shaped frame portion includes a bag of permeable net material, having a closed lower end and an open upper end. A selectively releasable elongate fastener extends along the upper end of the bag, and is configured to releasably wrap around and secure the upper end of the bag to the hoop-shaped frame portion. In one embodiment the selectively releasable elongate fastener is a zipper.

The present application is a continuation-in-part of U.S. patent application Ser. No. 10/616,460, filed on Jul. 8, 2003, which is a continuation of U.S. patent application Ser. No. 10/015,487, filed on Dec. 11, 2001, now U.S. Pat. No. 6,615,532 issued Sep. 9, 2003, the disclosures of which are incorporated herein by reference in their entireties.

### BACKGROUND OF THE INVENTION

1. Field of the Invention

The present invention relates generally to nets used in sport fishing. More particularly, the present invention relates to a sport fishing net that is easily attachable or removable from a fish net frame.

2. Related Art

Sport fishing is a popular pastime, and, accordingly, the production of sport fishing equipment has become a very large industry. Catch-and-release fishing, for example, is one method which has grown in popularity, either by regulation in some areas, or by the voluntary action of fishermen.

Sport fishermen, especially when fly fishing, typically use a handheld fish net for landing a fish, that is, scooping the fish out of the water. This is particularly true when fly fishing and when following catch-and-release procedures. Fly fishing practically requires netting because it is difficult if not impossible to land a fish without a net when fly fishing. When using a net or releasing a fish from a hook, it is desirable to subject the fish to as little handling as possible.

However, some handling is frequently necessitated by catch-and-release rules themselves. The rules regarding which fish must be released and which may be kept usually relate to the size of the fish, typically its length. Consequently, upon catching a fish and scooping it up in his net, a fisherman must remove the fish from the net (which is sometimes difficult because the fish is slippery, and is thrashing about), remove the hook from the fish, and place the fish adjacent to some measuring scale, such as a rigid ruler or flexible tape. Then, if the fish does not meet the length restrictions, the fisherman must put the fish back into the water.

All of these actions are difficult to perform, time consuming, and subject the fish to some level of trauma, sometimes needlessly. The time and trauma involved can sometimes lead to major injury, or even the needless death of the fish. Additionally, some fishermen, particularly novices, may desire a method of measuring a fish which does not require any physical handling of the fish at all.

Another common problem with typical sport fishing nets is that of replacing or exchanging a net on a given frame. Fish net frames tend to last much longer than the fabric nets that are attached to them. If one desires to replace a worn out net, there are really only two options. One option is to buy a completely new net, frame and all, and discard the old one, even though the frame may still be useable. This is wasteful. A second option is to purchase a new fabric net bag, and attach the new net bag to the existing frame. Unfortunately, while this option is not as wasteful, it is generally difficult and time-consuming. Typical replacement net bags must be sewn, stitched, tied, or otherwise attached to the frame in a time-consuming, tedious process. The very prospect of this process is enough to cause many fishermen to adopt the wasteful alternative, rather than continuing to use a perfectly good fish net frame.

Some sport fishing nets include a frame with a hoop portion that opens to allow one to thread a new net onto an existing frame. While this configuration simplifies the process of replacing a worn net, it requires the initial purchase of a more complicated (and probably more expensive) frame. Most fishermen are unlikely to purchase such nets. Moreover, where a fisherman does not have such a net frame in the first place, this option does not apply.

### SUMMARY OF THE INVENTION

It has been recognized that it would be advantageous to provide a fish net bag that can be easily attached to and detached from an existing fish net frame, so as to allow easy replacement of worn nets and to allow multiple types of nets to be attached to multiple types of frames.

It has also been recognized that it would be advantageous to develop such a net that provides a very quick method of determining the length of a fish held in the net and which reduces or eliminates human handling of the fish.

The invention advantageously provides a net for a sport fishing net device having a substantially hoop-shaped frame portion. The net comprises a bag of permeable net material, having a closed lower end and an open upper end. A selectively releasable elongate fastener extends along the upper end of the bag, and is configured to releasably wrap around and secure the upper end of the bag to the hoop-shaped frame portion. In one embodiment the selectively releasable elongate fastener comprises a zipper.

In accordance with a more detailed aspect thereof, in one embodiment the net bag includes a length measuring scale disposed on the net material, configured to allow a user to determine a size of a fish held in the net by visually comparing the fish with the length measuring scale.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a fish net with length measuring scale in accordance with one embodiment of the present invention.

FIG. 2 is a close-up flattened-out view of the length measuring scale of the fish net of FIG. 1.

FIG. 3 is a side sectional view of the fish net of FIG. 1, having a fish held in the bottom of the net in alignment with the measuring scale, illustrating the effects of curvature induced inaccuracy.

FIG. 4 is a perspective view of a fish net with a zipper for easy attachment to or removal from a fish net frame.

FIG. 5 is a perspective view of an alternative fish net with snaps for easy attachment to or removal from a fish net frame.

FIG. 6 is a perspective view of an alternative fish net with buttons for easy attachment to or removal from a fish net frame.

FIG. 7A is a cross-sectional view of a portion of the net frame and fish net bag with a zipper of FIG. 4.

FIG. 7B is a cross-sectional view of a portion of the net frame and fish net bag with snaps of FIG. 5.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

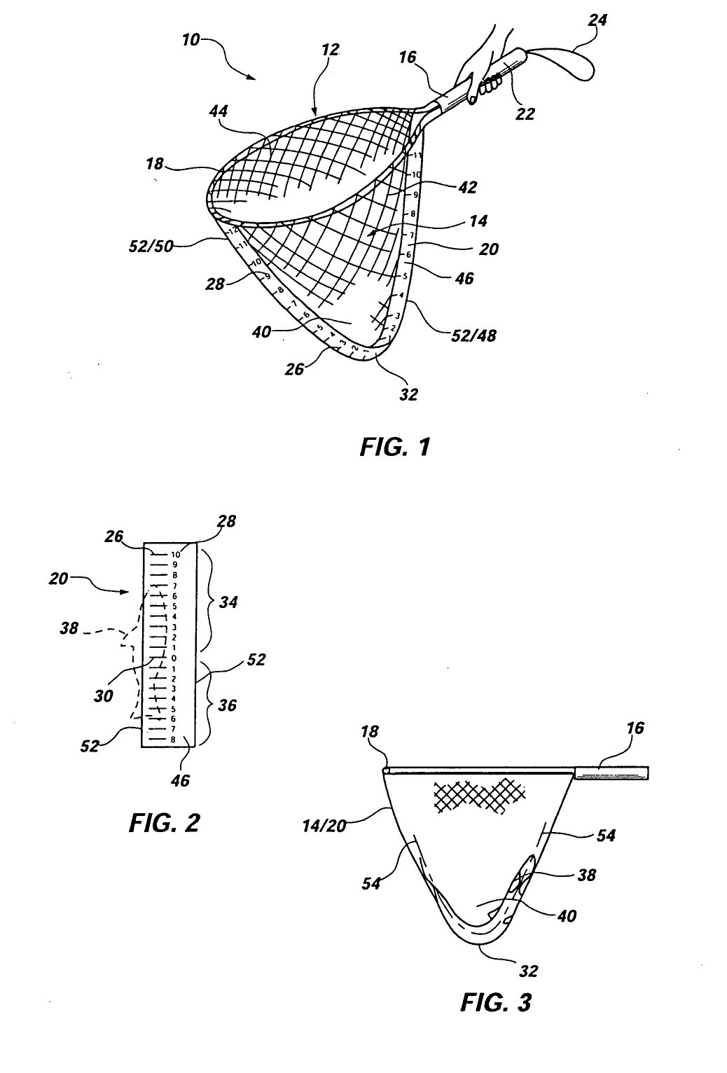

As illustrated in FIG. 1, in one embodiment, the fish net with length measuring scale invention described herein generally comprises a sport fishing net 10 having a frame 12, and a net 14 attached to the frame. In the embodiment shown in FIG. 1, the frame includes a handle 16, and a substantially closed loop portion 18 attached to the handle, the net 14 being attached to and hanging from the closed loop portion 18. It will be apparent that the frame could be configured in various ways other than that shown. However, the configuration shown in FIG. 1 is fairly typical of sport fishing nets, and will be familiar to many likely users.

The frame 12 may be formed of various materials, including aluminum, steel, wood, etc. The handle 16 is preferably provided with a rubber or rubber-like gripping surface 22, and may also include a loop 24 or other device which may serve as a safety strap, and may also be used for hanging storage of the net.

Disposed in a generally linear configuration along a surface of the net 14 is a length measuring scale 20, which may extend from one side to an opposing side of the closed loop portion 18. The orientation or alignment of the length measuring scale relative to the frame of the fish net may vary. As shown in FIG. 1, the length measuring scale extends from near the junction of the handle 16 and the closed loop portion 18. It will be apparent, however, that the length measuring scale could be oriented substantially transverse to the handle, or in many other orientations.

The length measuring scale 20 includes a series of length markings 26 and numeral designations 28. In one embodiment, the length markings 26 represent standard units of length, such as inches, centimeters, etc. With the net configured in this way, a user can easily determine the size of a fish held in the net by aligning the fish with the length measuring scale, and visually comparing the fish with the length measuring scale to determine its length in the units of the scale.

Referring to FIG. 1 and FIG. 2, the measuring scale 20 preferably includes a zero point 30 approximately in the center of the scale, which makes it particularly easy to use. The zero point is preferably located near the bottom 32 of the net, and the measuring scale 20 comprises two coordinated scales 34, 36 sharing the zero point, and extending in opposite directions therefrom.

In this configuration, a user can easily visually determine the length of a fish 38 (shown in outline) by substantially aligning the fish with the length measuring scale 20, and adding the numeral designations 28 which are approximately aligned with opposing ends of the fish. For example, as shown in the flattened-out view of FIG. 2, the ends of the fish 38 approximately line up with the numerals 7 and 6. Accordingly, if the length markings represent inches, the length of the fish is equal to approximately 13 inches.

It will be apparent that the length measuring scale 20 could be configured in other ways as well. For example, the zero point 30 could be at one end of the scale, such that upon viewing the numeral designations 28 which align with each end of the fish 38, the user must subtract the smaller numeral from the larger to determine the length of the fish. It will be apparent that the zero point could be at other locations as well.

Modified or non-standard units of length may be used in the length measuring scale 20, for reasons that will be more apparent hereafter. For example, the length units may be larger or smaller than standard length units. Alternatively, the length units may be graduated or non-linear, such that the distance between adjacent length markings 26 gradually increases or decreases as one moves along the scale in a given direction relative to the zero point. Similarly, the numeral designations could be any type of numerals, and are not limited to the set of Arabic numerals used by those who speak English.

In order to facilitate the rapid and easy alignment of the fish 38 with the measuring scale 20, the net 14 is preferably configured to form a pocket 40 into which the fish will naturally tend to rest in substantial linear alignment with the length measuring scale. In other words, it is preferable that the shape of the net be such as to naturally cause the fish to drop into a position aligned with the scale when a user scoops up a fish therein. If, upon initial placement of the fish in the net, the fish is not adequately aligned with the length measuring scale, the user may simply move the fish or juggle the net slightly to cause the fish to attain the desired alignment.

In one embodiment, forming the net into a pocket as describe is accomplished by assembling the net from first and second side pieces 42 and 44, and a substantially linear center piece 46. These three pieces are joined or sewn together along their edges. The first and second side pieces have curved edges 48 and 50, while the center piece has substantially linear side edges 52. Joining these edges thus forms an elongate pocket 40 into which a fish naturally tends to rest when scooped up into the net.

The net 14 may be made from any material which is flexible and strong enough for use as a fish net, which will not damage a fish, and which will allow water to freely flow through it. The side pieces 42 and 44 may be of the same material as the center piece 46, or they may be made of different materials. Suitable materials for the side pieces include a wide variety of mesh or net materials, such as cotton, nylon, and other polymer materials such as polypropylene rubber. Other materials may also be used. The same materials may be used for the center piece, with the additional requirement that the material of the center piece must be suitable for application of the length measuring scale thereto, whether by printing, marking, weaving, embroidery, etc., as discussed below. It will be apparent that some net materials may be unsuitable for having markings applied with inks, dyes, or silk screening, unless the characters in the markings are intended to be quite large.

The length measuring scale 20 may be disposed on the fish net 14 in various ways. In one embodiment, the length markings 26 and numerals 28 are woven into the fabric of the net, possibly using a different color or type of material to form the woven markings and numerals. This approach allows the markings and numerals to be visible on both sides of the net fabric, and makes the measuring scale equally useful regardless of whether a user inverts the net from a given orientation. However, it will be apparent that the numerals will present a mirror image when viewed on one side, when compared to the other. This method also tends to produce a durable scale, with length markings and numerals which cannot be merely rubbed off.

Alternatively, the length markings 26 and numerals 28 may be applied to the surface of the net 14 using a silk-screen or printing process, which applies the markings with inks, dyes, etc. There are a variety of these processes, and they are well known. The construction of the net using a substantially linear center piece 46, as described above, facilitates this approach by allowing printing on a flat, straight piece of material. It will be apparent, however, that the success of this approach may depend upon the nature of the net material where the scale is placed. It will also be apparent that the markings and numerals may not be as readily visible on one side of the net fabric unless the marking scale is printed on both sides. As yet another alternative, the length markings and numerals could be embroidered onto the fabric of the net. As in the case of the woven markings, this approach also produces a durable scale.

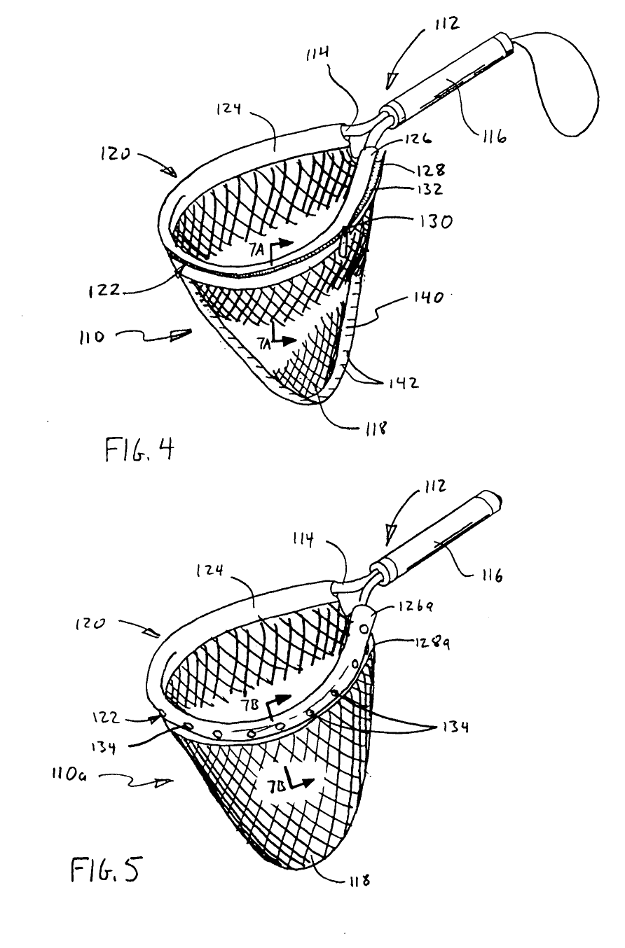

As noted above, the length measuring scale may comprise modified units of length. Referring to FIG. 3, this may be done to compensate for relative curvature of the fish 38 and the length measuring scale 20. It will be apparent that, when a fish is held in a fish net of the type illustrated in FIG. 1, it will tend to rest on its side in the bottom of the net 32, in a curved position, as shown in FIG. 3. When a fish is measured on a flat scale, its thickness does not substantially affect its apparent length. However, when curved and resting in the bottom of a net, the central axis 54 of the fish 38 is offset from the scale 20 due to the thickness of the fish, and, since the central axis and the scale are both curved, the fish may appear to be longer than it really is.

Consequently, the distance between the length markings 26 may be modified to compensate for this curvature-related error. For example, if the scale 20 is intended to be in inches, each length marking may be slightly more than one inch from its adjacent marking so that the fish will not appear to be longer than it is. The actual variation in the distance between markings may be determined by trial and error. Additionally, because the difference may vary depending on the type of fish, nets with different modified units may be made for different types of fish.

Additionally, because the error may depend on the thickness of the fish, longer fish may tend to introduce more error because they will generally include thicker portions. Thus, a length measuring scale 20 in which the units are modified in a non-linear manner may be desirable. For example, a graduated or semi-logarithmic scale may be disposed on the net 14, such that the distance between length markings gradually increases with distance from the zero point 30. Other variations may also be used. Because there is little visible difference between them, the length measuring scales depicted in FIGS. 1 and 2 are intended to represent all length measuring scales described herein, whether based on standard or constant units, or modified units.

Several other embodiments of the invention are shown in FIGS. 4-7. These embodiments provide a net bag that is selectively releasable to the fish net frame, so that the net is easily attachable to or removable from the frame for easy replacement. This allows nets, which tend to wear out faster than their associated frames, to be more easily replaced.

Viewing FIG. 4, the replaceable net embodiment of the invention includes a net bag 110 that is releasably attachable to a fish net frame 112. The frame includes a substantially hoop-shaped portion 114 to which the net bag is attached, and a handle 116 attached to the hoop-shaped portion. The releasably attachable net comprises a bag of permeable net material, such as mesh or net materials of cotton, nylon, polypropylene and other materials. The bag has a closed lower end 118 and an open upper end 120. Extending along the open upper end of the bag is a selectively releasable elongate fastener 122 attached along a flexible upper rim 124 of the bag. The flexible rim is configured to wrap around the hoop-shaped frame portion, and be secured together by the fastener so as to secure the upper end of the bag to the frame. This selectively replaceable net bag allows a user to quickly and easily attach nearly any net to almost any type of frame. To attach the fabric net to the frame, the user simply places the upper open end of the bag adjacent to the hoop-shaped frame portion of the fish net frame. The user then fastens the releasable fastener around the hoop portion of the frame along its length, so as to secure the bag to the frame portion.

It will be apparent that it is desirable that the length of the upper end 120 of the bag 110 not differ excessively from the length of the perimeter of the hoop-shaped portion 114. In other words, the size of the bag should generally correspond to the size of the hoop. If the upper end of the bag is too short, i.e. the opening of the bag is too small compared to the opening of the frame, the bag will not be able to be fastened to the frame. If it is too long, however, the upper end of the bag will tend to pucker and bunch up along the length of the frame, in an unsightly way. Preferably, the size of the upper end of the bag and the length of the perimeter of the hoop portion of the frame are selected so that the releasable fastener 122 secures the bag around a majority of the perimeter of the hoop portion of the frame, as shown in the figures.

In the embodiment shown in FIGS. 4 and 7A, the flexible rim 124 includes opposing portions 126, 128, and the selectively releasable elongate fastener 122 comprises a zipper 130 disposed along the opposing portions of the rim. In order to minimize deterioration from contact with water (e.g. rusting) the teeth 132 and other relatively rigid parts of the zipper can be made of corrosion-resistant materials, such as stainless steel, aluminum, or polymers.

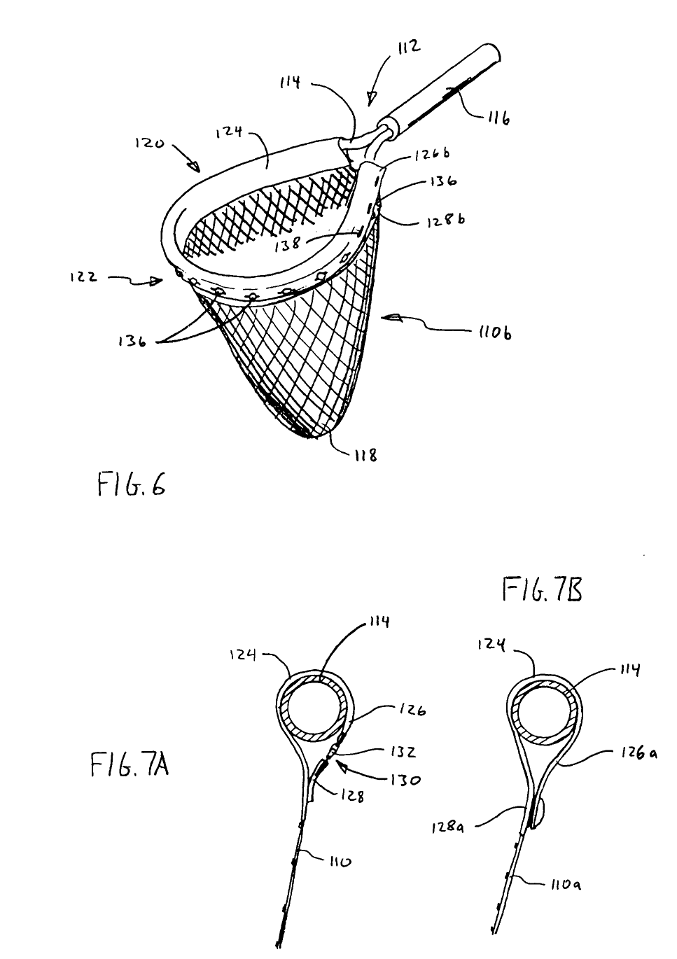

It will be apparent that fasteners other than zippers can be used. For example, as shown in FIGS. 5 and 7B, the net bag 110a can include fastener 122 comprising a series of snaps 134 disposed along the opposing portions 126a, 128a of the top rim 124. Alternatively, as shown in FIG. 6, the fastener of the net bag 110b can comprise a series of buttons 136 disposed along one portion 128b of the rim, with corresponding button holes 138 disposed along the opposing rim portion 126b. Other types of fasteners can also be used. Any fastener system that causes the upper end 120 of the bag to releasably wrap around the hoop-shaped portion 114 of the fish net frame 112 will be suitable. Again, to minimize deterioration from contact with water, the snaps, buttons, or other fasteners can be made of corrosion-resistant materials.

The selectively releasable net bag 110 can be any type of bag, in almost any configuration. As shown in FIG. 4, in one embodiment, the releasable net bag includes a length measuring scale 140 configured and used as described above with respect to FIGS. 1-3. The measuring scale is permanently disposed generally linearly on a surface of the net material, and can be configured to extend from a first position adjacent the upper end of the bag, thence substantially across the closed end of the bag, to a second position adjacent the upper end of the bag and substantially opposite the first position. As described above, the length measuring scale can include length markings 142, either standard or modified units, and numeral designations associated with the length markings. The length markings can include a zero point near the bottom of the net bag, with two coordinated scales sharing the zero point and extending in opposing directions therefrom, so that a user may visually determine the length of a fish held in the bag by substantially aligning the fish with the length scale, and adding the numeral designations which are approximately aligned with opposing ends of the fish.

It will be apparent that the selectively releasable net 110 is not limited to nets including a length measuring scale. For example, the net bag 110a shown in FIG. 5 does not include a length measuring scale, nor does the net bag 110b of FIG. 6.

Advantageously, the selectively releasable net bag provides a fish net system, wherein any of a plurality of fish net frames can be selectively connected to any desired one of a plurality of net bags configured in accordance with the invention. This configuration allows any type of net to be attached to any desired type of frame. While the cross-sectional views of FIGS. 7A and 7B depict a tubular frame, such as of aluminum or other metal, the invention is not so limited. For example, where a sport fisherman desires a particular type of net (e.g. a measuring net) on a particular type of frame (e.g. a laminated wood frame), the desired combination is obtainable simply by combining the separate components together, rather than having to find a completed product that includes both desired components. Depending on the particular combination desired, finding the completed product can be very difficult. However, the present invention makes an essentially custom-designed sport fishing net inexpensive and easy to obtain. It also allows suppliers of fish nets to sell a variety of nets and frames separately, allowing customers to mix and match as desired.

It is to be understood that the above-described arrangements are only illustrative of the application for the principles of the present invention. Numerous modifications and alternative arrangements can be devised without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth in the claims.

1. A net for a sport fishing net device having a substantially hoop-shaped frame portion, the net comprising:
a bag of permeable net material, having a closed lower end and an open upper end; and
a selectively releasable elongate fastener having opposing portions, extending along a majority of a length of the upper end of the bag, the opposing portions being configured to wrap around the hoop-shaped frame portion and releasably attach to each other to releasably secure the upper end of the bag to the hoop-shaped frame portion.

2. (canceled)

3. A net in accordance with claim 1, wherein the selectively releasable elongate fastener is selected from the group consisting of a zipper, snaps, and buttons.

4. A net in accordance with claim 1, wherein the bag includes a length measuring scale, comprising indicia directly disposed on a surface of the net material.

5. A net in accordance with claim 4, wherein the measuring scale extends from a first position adjacent the upper end of the bag, thence substantially across the closed end, to a second position adjacent the upper end of the bag and substantially opposite the first position.

6. A net in accordance with claim 4, wherein the length measuring scale includes length markings and numeral designations associated with the length markings.

7. A net in accordance with claim 6, wherein the bag includes a bottom at the closed end, and the length markings include a zero point near the bottom, with two coordinated scales sharing the zero point and extending in opposing directions therefrom, whereby a user may visually determine the length of a fish held in the bag by substantially aligning the fish with the length scale, and adding the numeral designations which are approximately aligned with opposing ends of the fish.

8. (canceled)

9. A net in accordance with claim 4, wherein the length measuring scale includes length markings representing modified units of length to compensate for curvature of a fish held in the bag.

10. A fish net system, comprising:
a fish net frame, having a substantially hoop-shaped portion; and
a bag of permeable net material, having a closed lower end and an open upper end, the bag including a selectively releasable elongate fastener having opposing portions, extending along a majority of a length of the upper end of the bag, the opposing portions being configured to wrap around the hoop-shaped portion and releasably attach to each other to releasably connect the bag to the hoop-shaped portion of the fish net frame.

11. A fish net system in accordance with claim 10, wherein the fish net frame further comprises a handle attached to the hoop-shaped portion.

12. (canceled)

13. A fish net system in accordance with claim 10, wherein the selectively releasable elongate fastener is selected from the group consisting of a zipper, snaps, and buttons.

14. A fish net system in accordance with claim 10, wherein the bag includes a length measuring scale, comprising indicia directly disposed on a surface of the net material.

15. A fish net system in accordance with claim 14, wherein the measuring scale extends from a first position adjacent the upper end of the bag, thence substantially across the closed end, to a second position adjacent the upper end of the bag and substantially opposite the first position.

16. A fish net system in accordance with claim 14, wherein the length measuring scale includes length markings and numeral designations associated with the length markings.

17. A fish net system in accordance with claim 16, wherein the bag includes a bottom at the closed end, and the length markings include a zero point near the bottom, with two coordinated scales sharing the zero point and extending in opposing directions therefrom, whereby a user may visually determine the length of a fish held in the bag by substantially aligning the fish with the length scale, and adding the numeral designations which are approximately aligned with opposing ends of the fish.

18. (canceled)

19. A fish net system in accordance with claim 14, wherein the length measuring scale includes length markings representing modified units of length to compensate for curvature of a fish held in the bag.

20. A fish net system, comprising:
a plurality of fish net frames, each frame having a substantially hoop-shaped portion; and
a plurality of bags of permeable net material, each bag having a closed lower end and an open upper end, and including a selectively releasable elongate fastener extending along a majority of a length of the upper end of the bag, the elongate fastener having opposing portions that wrap around the hoop-shaped portion and releasably connect to each other, the elongate fastener configured to releasably connect the bag to the hoop-shaped frame portion such that any of the plurality of bags may be connected to the hoop-shaped portion of any of the plurality of fish net frames.

21. A net for a sport fishing net device having a substantially hoop-shaped frame portion having a perimeter, the net comprising: a bag of permeable net material, having a closed lower end and an open upper end having a flexible rim extending therealong; and
a zipper, extending along the flexible rim, configured to releasably wrap the rim around the hoop-shaped frame portion so as to releasably secure the bag to the frame portion along a majority of the perimeter of the frame portion.

22. (canceled)

23. A method for attaching a fabric net to a fish net frame, comprising the steps of:
placing a flexible rim of an upper open end of a bag of permeable material having a closed lower end and an open upper end, the flexible rim extending along a majority of a length of the open upper end, adjacent to a substantially hoop-shaped frame portion of a fish net frame; and
releasably fastening a selectively releasable elongate fastener extending along opposing portions of the flexible rim around the hoop-shaped frame portion so as to releasably secure the bag to the frame portion.

24. A net in accordance with claim 21, wherein the bag includes a length measuring scale, comprising indicia directly disposed on a surface of the net material.

25. A net in accordance with claim 24, wherein the measuring scale extends from a first position adjacent the upper end of the bag, thence substantially across the closed end, to a second position adjacent the upper end of the bag and substantially opposite the first position.
